(19) United States
(12) Patent Application Publication
(10) Pub. No.: US 2003/0178480 A1
(43) Pub. Date: Sep. 25, 2003

(54) System and method for determining golf ball distance per golf stroke

(76) Inventor: Craig H. Mogensen, (US)

Correspondence Address: Craig H. Mogensen, 6102 S. Boston Circle, Englewood, CO, 80111, US

(21) Appl. No.: 10/102,257

(22) Filed: Mar. 20, 2002

(51) Int. Cl. G01C 22/00

(52) U.S. Cl. 235/96

(57) ABSTRACT

A system and method for accurately measuring the distance traveled by a golf ball per golf stroke. An odometer-type device measures the distance traveled by a golf cart by measuring the number of rotations of a wheel of the golf cart as it travels between a first and second position. The number of rotations are then converted by the device to yardage and displayed on the device to represent the relative distance traveled by the golf ball. The system and method are configured to concurrently measure the distance traveled by first and second golf balls concurrently.

### FIELD OF THE INVENTION

The present invention relates generally to golf and more particularly to a system and method that determines accurate distance traveled by a golf ball per golf stroke.

### BACKGROUND OF THE INVENTION

A common system for measuring distance between a golf ball and various fixed positions, such as a tee box or a pin. This system relies on a complicated combination of global positioning satellites (GPS), a fixed GPS receiver, a mobile GPS receiver and a computer capable of mathematical calculations of relative distances between the fixed and mobile GPS receivers. This derived distance is then combined with a measured distance between the mobile GPS receiver and the location of the golf ball to determine the distance between the golf ball and the pin to which the golfer is aiming. There are several other, less complex systems and methods (e.g. sprinkler-head based yardage measurements) that provide golfers information about the distance from the present golf ball location to another location—usually the green or pin (sometimes a golf hazard).

U.S. Pat. No. 5,364,093 to Huston et al, issued Nov. 15, 1994 teaches that the distance between the pin on a green and a mobile cart may be determined using GPS data transmitted from GPS when the exact location of the pin on the green and the exact location of the mobile golf cart are each known. The Huston et al teaching provides for previously determining the exact location of the pin on the green, by independent means. The mobile cart is provided with a GPS receiver and a computer. The GPS receiver receives GPS data which, when translated, defines an inaccurate location for the mobile cart. A differential or error correction signal is used to change the inaccurate location of the golf cart to a correct location. The distance between the accurate location of the mobile golf cart and the previously determined location of the pin on the green is then calculated from two defined accurate locations.

The differential or error correction signal is generated by comparing position locating data derived from GPS data received by a fixedly located GPS receiver with previously determined, corresponding position locating data defining the exact, correct location of the fixedly located GPS receiver. The differential signal is transmitted to the mobile GPS receiver on the golf cart. The exact location of the mobile cart is determined by correcting the GPS data defining the inaccurate location of the mobile GPS receiver on the golf cart with the differential signal.

U.S. Pat. No. 5,434,789 to Fraker et al, issued Jul. 18, 1995 teaches a golf diagnostic system which uses GPS data for plotting locations for measuring the flight of a golf ball and for measuring distance between the GPS receiver and other previously known locations on the golf course. The teaching includes using differential or error correction signals generated by and transmitted from a fixed GPS receiver, located in a previously known and defined location, to adjust location coordinates, for accuracy. However, the teachings of both Huston et al, '093 and Fraker et al, '789 require the generation of differential or error correction signals. It is also necessary, in both teachings, to know the exact, defined location of at least one GPS receiver, in terms compatible with the GPS data, in order to compare the GPS data defined location with the actual location in order to generate a differential signal. The differential signal must be applied to a second GPS data defining the location of a second GPS receiver in order to determine the correct location of the second GPS receiver. It is further necessary to know the exact, defined location of the pin in order to measure distance between the pin and a mobile GPS receiver.

Radio transmitters have also been used to determine golf ball locations on a golf course. U.S. Pat. No. 5,056,106 to Wang et al, issued Oct. 8, 1991 teaches that distances between a golf player and predetermined objects located on a golf course may be determined by using a plurality of radio transmitters positioned throughout the vicinity of the golf course. The radio transmitters, in predetermined locations, broadcast codified, spread-spectrum RF signals that are received by a hand-held receiver/processor that computes distances between the receiver and objects on the golf course. The teaching of Wang et al is overly complicated and expensive in equipment, installation and maintenance.

Finally, a simple system was proposed by Cormier. U.S. Pat. No. 4,815,020 to Cormier, issued Mar. 21, 1989 teaches that the distance between a golf ball and the green remaining after the tee-off flight of the golf ball, may be determined by measuring the distance of the flight of the golf ball from the tee and calculating the distance between the golf ball and the green, since the distance between the tee and the green is already known. “An object of [Cormier's] invention [is] to provide the method and means of providing information about typical, recent club performance, and about the distance remaining to the pin in a convenient, reliable, and timely fashion.” (See Col. 1, lines 27-31). Cormier teachings provide for measuring the distance of the flight of the golf ball from the tee using dead reckoning, with no capability to calibrate the measuring device to the wheel of the pull cart. Moreover, Cormier relies on an approximation of ball flight distance and is not adaptable to other golf equipment carrying devices. The basic measurement of distance used by Cormier is the distance from the center of the tee to the center of the green, not necessarily to the pin on the green. Since Cormier is directed to predicting selected club performance and remaining distance to the pin, Cormier does not teach how to determine distance traveled per golf stroke, or how to accommodate two different golfers.

There is a need in the industry to provide an accurate measurement of golf ball distance traveled per stroke without the expense commonly associated with other measuring systems. Furthermore, there is a need in the industry to provide such a system that is adaptable from a motorized golf cart to manual pull cart, to all golf equipment and golfer carrying vehicles.

### SUMMARY OF THE INVENTION

The present invention provides golfers with a measurement of yardage (i.e., golf ball travel distance) between the striking point of the golf ball and the landing location. The invention is a calibratable, odometer device that measures the distance traveled by motorized golf carts, manual or electric pull carts and other golf bag and golfer carrying devices. The device displays that distance as a function of yardage traveled, providing one or two golfers with a read-out of yardage traveled on a cumulative basis relative to the most recent “reset” of the device. The “reset” feature can index the traveled distance measured by the device to zero.

With the present invention, a golfer can position the golf cart next to the golf ball, “reset” the invention to zero, strike the golf ball, travel to the new golf ball position, and receive yardage distance information from the invention. One of the benefits of the claimed device is immediate feedback about the ball distance traveled for various club selections, golf courses, ground and wind conditions and other golfer/equipment and environmental factors.

This system and method of measuring golf ball distance traveled is unique as it provides data on the distance that a golf shot has been hit, after the golf shot, as opposed to other methods, such as the complicated GPS systems described above, which provide information about the distance from the present golf ball location to the green or pin. Furthermore, the claimed invention provides the capability to calibrate the device to the specific wheel radius of the golf equipment-carrying vehicle so that the total shot distance can be accurately represented. Other inventions that have failed to provide this capability limit the prior art devices' accuracy or limit the devices to specific golf vehicle apparatus such as a certain type of wheeled, hand-drawn carts.

The present invention provides a system and method that measures the distance traveled by a golf ball per golf stroke per player. The system comprises a device electrically coupled to the wheel of a golf cart. The device calculates the corresponding distance traveled by each golf shot from point A to point B using the characteristic circumference of the wheel of the cart. The number of rotations taken by the wheel between point A and point B is measured and multiplied by the wheel circumference (using the characteristic radius) and the resultant distance is displayed in yardage. Input buttons are provided for calibrating the device, resetting each player's display, “suspending” the accumulation of yardage data (for cart travel that should not be included in determining golf shot distance) and for operating other standard and optional features.

### BRIEF DESCRIPTION OF THE DRAWINGS

FIGS. 1a and 1b show simple golf carts, both a pull model and a motorized model.

FIGS. 2a and 2b show perspective views of the golf cart and wheel, along with the claimed device.

FIG. 3 shows a simple flow diagram of a method for determining distance traveled by a golf ball per golf stroke.

FIG. 4 shows a sample diagram of the distance traveled by two golf balls during play of one hole.

FIG. 5 shows a functional block diagram of the claimed device.

FIG. 6 shows a more detailed functional block diagram of the claimed invention.

### DETAILED DESCRIPTION OF THE PREFERRED EMBODIMENT

Briefly, the present invention provides a system and method that measures the distance traveled by a golf ball per golf stroke. The invention is an odometer-type device that measures distance traveled by a golf cart, both motorized carts and pull carts. One unique feature of the device is that it provides an accurate yardage measurement of distance traveled based upon calibration to the tire of the golf cart. This concept of measuring accurate yardage for the golfer is a unique application of an odometer type system.

The device works by measuring the number of rotations of the tire of the golf cart. The device determines the number of rotations of the tire, or suitable “drive train” mounting location, using either a mechanical or magnetic “proximity” approach (e.g., a Hall-effect sensing device)—depending on the target vehicle. Each rotation of the tire is translated into yardage distance by a simple electronic microprocessor and displayed on matrix, liquid crystal, seven segment, or other, display. The number of rotations sensed by the invention is determined by attaching a small rotating mechanical device or proximity sensor to the wheel or drive train assembly of the manual pull cart or motorized golf cart. In one embodiment, the rotation sensor has an umbilical—either mechanical or electrical depending on the cart type and model—that attaches to the device. A second embodiment uses electronic transmission to send the pulse count information. The present device display and processor assembly is designed to attach to several different candidate-mounting locations on the golf cart so that the golfer(s) can easily view the display.

The processor is programmed to translate the number of rotations of the carrier vehicle wheel into the number of yards. The processor is designed for easy calibration by the installer or end user (i.e., golfer) by entering a “calibration mode” on the device. The calibration mode is initiated by pressing a small, recessed button located on the device. Once pressed, this button combined with the device display permits the installer to enter the radius/circumference of the wheel of the golf cart in inches.

The processor uses the calibration value provided by the installer, that is stored in non-volatile memory, and combined with the dynamic rotation information, calculates the number of yards traveled. The processor displays the resulting yardage value on a display. The “displayed” yardage measurement can be reset to zero using the “yardage reset” button located conveniently on the housing of the device.

There is either one or two yardage displays and related reset buttons depending on whether the model is designed for a two-golfer motorized cart, or a single golfer pull or motorized bag carrier cart. The unit can be powered by one of two methods, either a battery that is contained within the housing of the device or an electrical hookup to the golf cart's electrical system.

Another feature of the invention is the capability to “suspend” the measurement of yardage even as the cart continues to move. When this capability is activated, by depressing a “suspend” button, all yardage accumulation and displays will remain static while the golf cart moves. Yardage “counting” may be resumed by pressing the suspend button again. By using this feature, golfers may eliminate distance traveled by the cart that does not represent flight distance (e.g. 90-degree cart rules) that would distort the actual measure of golf shot distance.

The preferred embodiment includes several other related features. These features include a clock that shows the elapsed time of the golf round, or other segment of time, and an additional display that shows the remaining yardage based upon an initial entry of yardage and the reduction of the yardage value based upon distance traveled (see below).

The clock feature provides a display of elapsed time, hours and minutes relative to the most recent “reset” of the time. The device has a clock processor and display integrated into the housing. Located on the side or front of the housing is a clock reset button that sets the initial time to zero. The clock begins keeping elapsed time in hours and minutes following the clock reset. The intent of the clock display is to provide the golfer(s) an indication of elapsed playtime for the golf round.

Another feature is an additional display that shows the net remaining yards to the green or other location, based upon an initial user entry of total yards. A golfer may set the total yardage for a particular golf hole and have this value displayed on the claimed device. This operation would normally be performed at the golf “tee box” location. Once a yardage value is entered, the device will count down the yardage as the golf cart progresses toward the green using the same rotation and calibration information that is used for the display of shot distance (“counting down” versus “counting up”). In this manner the golfer(s) will have a measurement of the total yardage distance remaining between the golf cart position and the green or other location (such as a hazard).

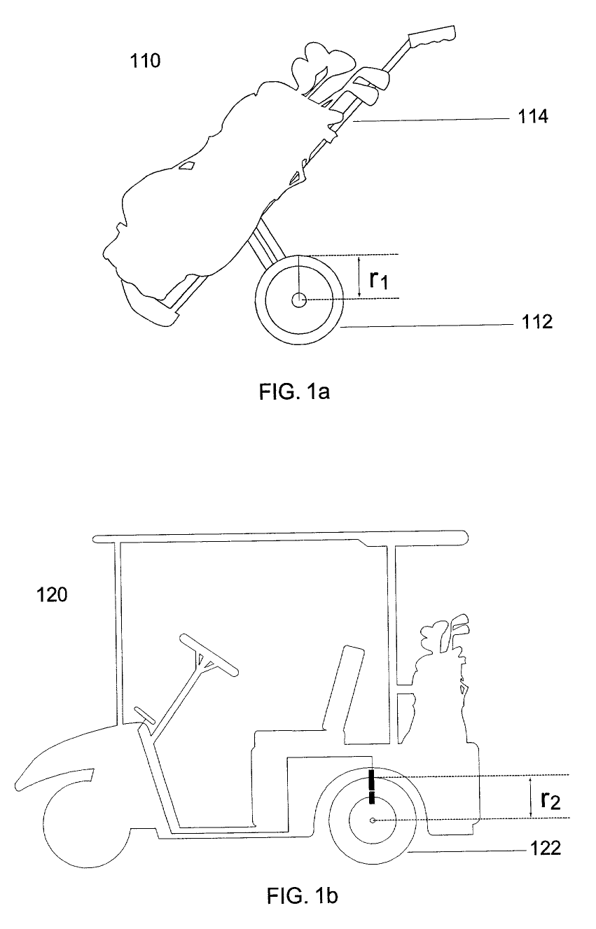

The claimed apparatus will now be described with reference to FIGS. 1a and 1b. FIG. 1a shows a pull golf cart 110 comprising wheels 112 with a first characteristic radius r₁. The claimed device (not shown) can be mounted on the handle 114 of the cart, for example, to provide easy access to the golfer for reading the display and resetting the measured yardage to zero. As will be discussed in further detail below, the first characteristic radius r₁ (and associated circumference) is determinative of the distance traveled of the wheel 112 in one complete revolution or rotation. FIG. 1b shows a simple motorized golf cart 120 comprising wheels 122 with a second characteristic radius r₂.

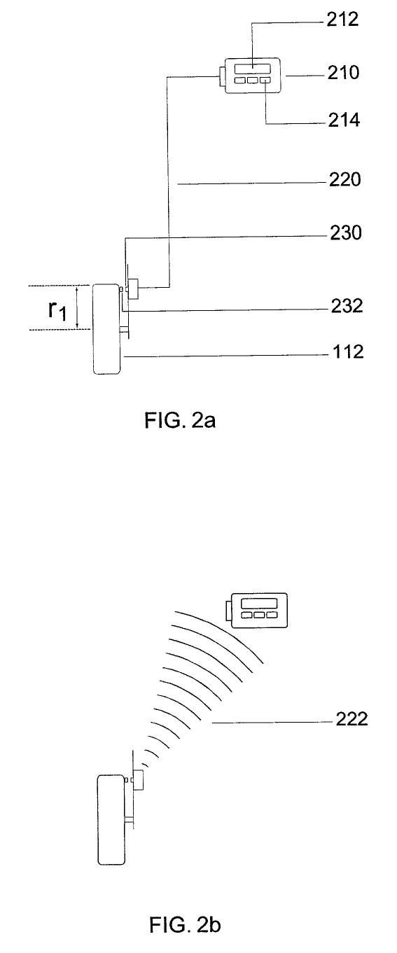

FIG. 2a shows a perspective view of the simple golf cart and wheel 112. Mounted on wheel 112 and the body of the cart is a rotation sensor pair 230 (body) and 232 (wheel). Sensors 230 and 232 act in concert to record one revolution, or rotation, of the wheel 112. This rotation information is transmitted in the form of pulse information to the claimed device 210 via a conducting wire 220. An alternative embodiment shown in FIG. 2b shows such rotation information being transmitted via a radio frequency signal 222.

The device 210 receives the rotation information and uses such information to calculate the distance traveled by measuring the number of rotations and using the characteristic radius r₁ (entered via the calibration feature) according the following formula:

[(# of rotations)*(2πr₁)]/36,

where the number of rotations is measured by the rotation sensor pair 230 and 232; 2πr₁ is the characteristic circumference of the wheel 112 based on the first characteristic radius (r₁) in inches; and 36 is used to convert inches to yards.

In its simplest incarnation, the device 210 comprises a display 212 and one or more input buttons 214. The display 212 can be a liquid crystal display, for example, or other type of display technology such as light-emitting diodes (LED), and even mechanical digits. Display 212 is configured to show distance traveled in yardage. Additional features of the device 210 permit display 212 to show time of day, as well as elapsed time for time played in a particular round of golf, and estimated remaining yardage distance to the green.

Input buttons 214 are provided to calibrate the device 210 by allowing the golfer or a golf course attendant to input the characteristic radius/circumference of the wheel of the cart to which the device 210 is attached, such information may typically be provided by the golf cart manufacturer. Of course, other more accurate measurements can be used to calibrate the device, including the diameter and circumference of the wheel. One preferred calibration measurement will be to use the drive wheel circumference due to the increased accuracy of yardage measurement provided by this value. A simple cloth ruler can be used to precisely determine the circumference value which can then be entered as the “calibration value” to allow the processor to accurately display the shot yardage distance.

Other functions of the input buttons 214 include a reset function that permits the golfer to reset the yardage distance to zero after each golf stroke, in preparation for the next golf shot. Wire 220 (or RF connection 222) transmits rotation data collected by sensor pair 230 and 232 to the device 210. Sensors 230 and 232 can either be a mechanical or a magnetic proximity type sensor including a magnet and sensor pair.

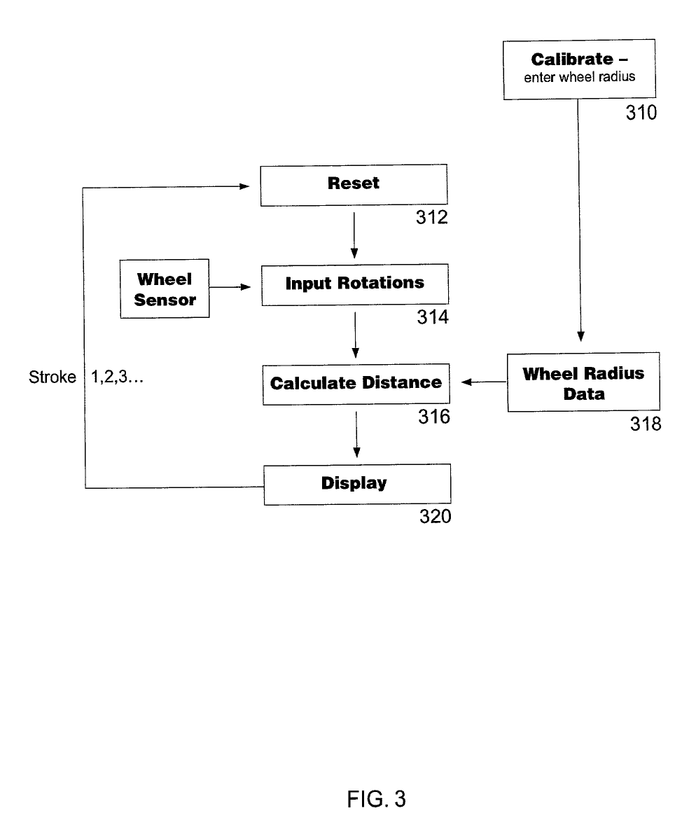

FIG. 3 shows a simple flow diagram of the present method. Block 310 allows the golfer or a golf course attendant to enter the wheel radius/circumference of the manual pull cart or the motorized golf cart. The calibration value is stored in non-volatile memory 318 and accessed by the processor for calculations. Once calibrated, block 312 resets the yardage measuring data to zero. Block 314 enters the number of rotations the wheel takes from start to finish positions. This information is then used to calculate the distance traveled via block 316. Finally, the distance traveled that was calculated by block 316 is displayed via block 320 before returning control to the reset block 312.

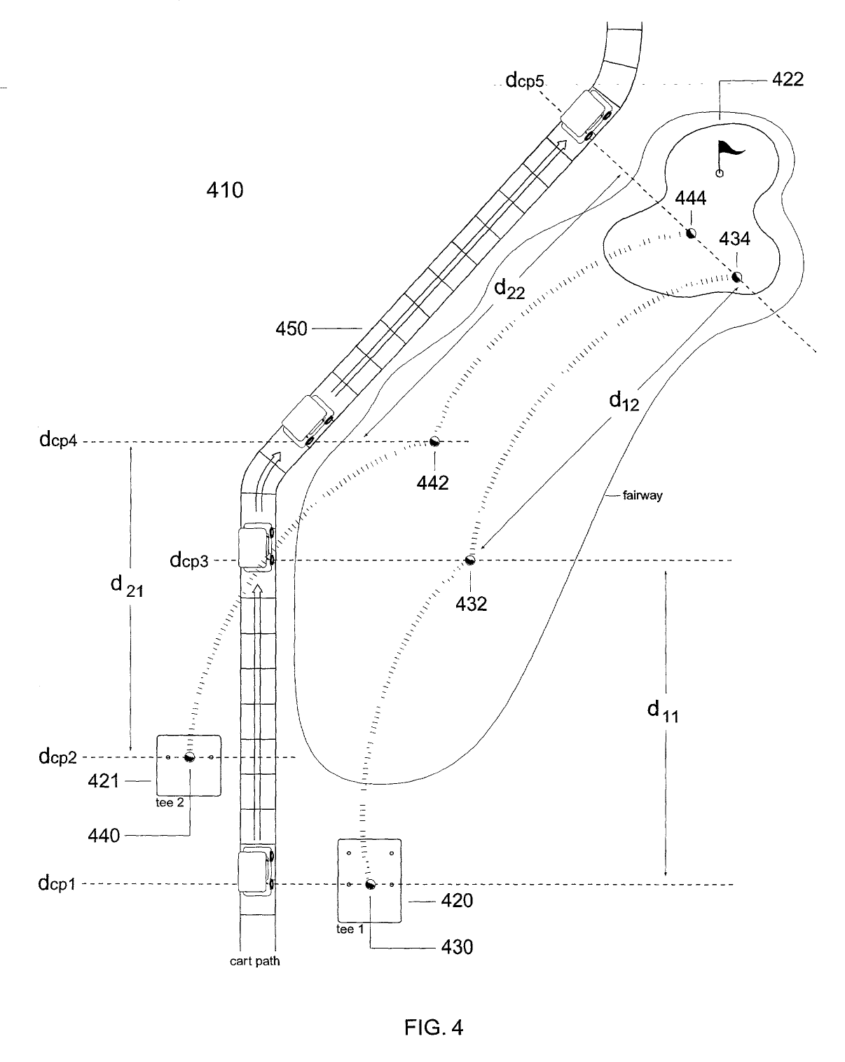

FIG. 4 shows a sample diagram of the distance traveled by two golf balls during play of one hole 410. In this illustrative example, golfer #1 begins by hitting their golf ball at tee box 420, location 430. After golfer #1 strikes the first ball, it travels to point 432. The second stroke causes the ball to travel to point 434 on the green 422. Each stroke causes the ball to travel a unique distance, d (represented by d₁₁, and d₁₂). Position d_{cp1} is the cart position for golfer #1 during their first golf stroke. Golfer #1 would push the reset button #1 on the device so their yardage display will show “0” yards. The golfer would also enter the total yards for the hole on a separate display using the appropriate “set” buttons on the devices. The data on the total yards for the hole may generally be obtained from the scorecard or a marker located on the tee box.

The second golfer (golfer #2) hits their first shot from tee box 421, location 440. After golfer #2 strike their golf ball, it travels to point 442. The second stroke causes the ball to travel to point 444 on the green 422. Each stroke causes the ball to travel a unique distance, d (represented by d₂₁ and d₂₂). Position d_{cp2} is the cart position (on cart path 450) for golfer #2 during their first golf stroke. Golfer #2 would push reset button #2 on the device so their yardage display will show “0” yards. After golfer #2 hits their first golf shot the cart then proceeds to cart position d_{cp3} at a location that is “even” with the resting location of golfer #1's first shot position 432.

In this illustrative example, the motorized golf cart travels the cart path designated by item 450. At cart position d_{cp3} golfer #1 can get a measurement of the total yards traveled by their first shot since they are located an equal distance from the tee box as shot location 432. Golfer #1 may walk to their ball at shot location 432 and hit their second shot or the “suspend” button may be pressed on the device and the cart can travel from the cart path 450 to shot location 432 without aggregating additional yardage that would distort the counting of golfer #2's first shot distance, or the display of the remaining distance to the green.

After golfer #1 has hit their second shot they would press reset button #1 to set their shot yardage distance back to zero so that the shot measurement for their second shot can begin. If the cart has traveled from the cart path 450 to the shot location 432 the “suspend” button must be pressed again when the cart returns to the cart path in order to resume counting yardage distance as the cart proceeds to cart position d_{cp4}. This perpendicular traverse (90 degree transverse) between the cart path and ball location is illustrative of the 90-degree cart rules that many golf courses have in effect to protect the fairways and the device's suspend feature is designed to accommodate these situations.

At cart position d_{cp4} golfer #2 would receive the shot yardage distance information from the display on the device. Note that the golf cart is stopped in a position “even” with the resting location of golfer #2's first shot at position 442. Golfer #2 may walk to ball position 442 and hit their second shot or use the suspend feature to permit the golf cart to traverse the distance between the cart path 450 and the shot position 442 without distorting the yardage measurements. At ball position 442, golfer #2 would hit their second shot, and then reset their yardage display to 0 (with reset button #2) to begin the process of measuring the yardage for the second shot which comes to rest at position 444. The shot measurement process continues as the cart proceeds to cart position d_{cp5} where the second shot yardage for both golfer #1 (position 434) and golfer #2 (position 444) can be obtained from their individual displays. The total yardage for the hole that was entered by golfer #1, at cart position d_{cp1}, should have counted down to zero.

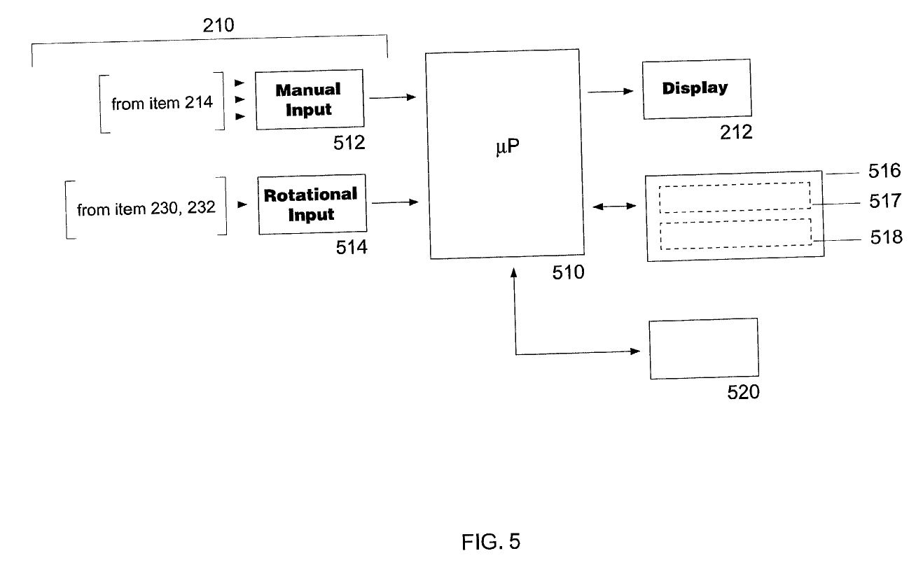

FIG. 5 shows a functional block diagram of the device 210. Inputs from the input buttons of FIG. 2 (items 214) are brought into the processor 510 via input port 512, while rotation data collected by sensor pair 230 and 232 is brought into the processor 510 via port 514. The display 212 is electrically driven by the processor 510 to display distance information, for example. Memory 516 houses the “brains” of the device 210, including distance calculations 517 and clock functions 518. In a preferred embodiment, memory 520 may also be used to store data for performance analysis.

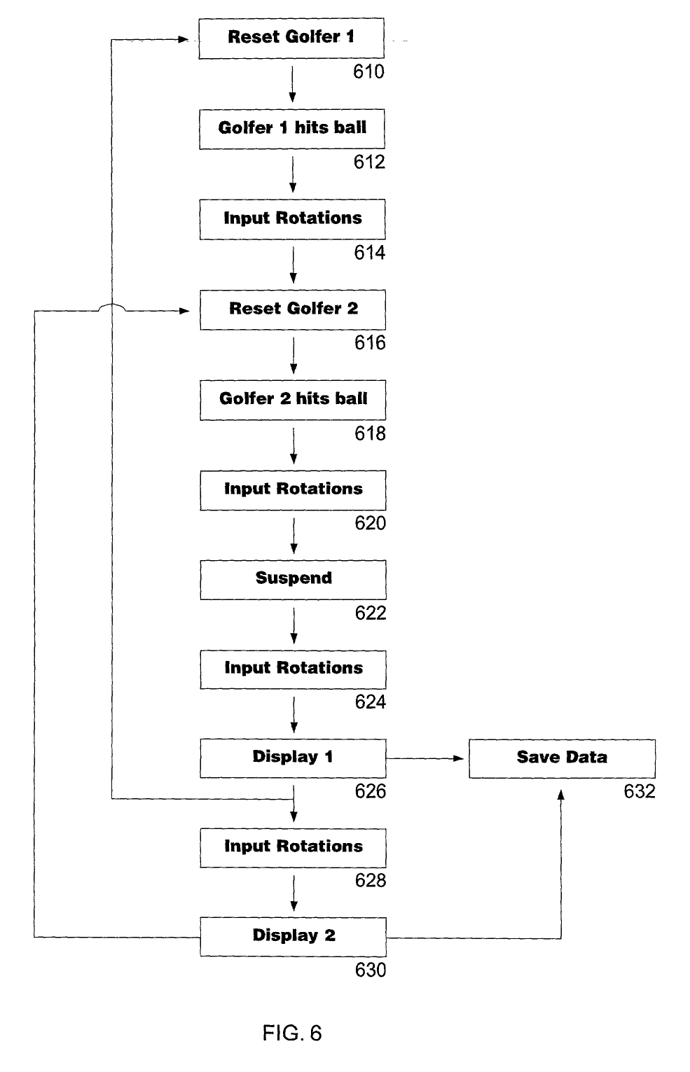

FIG. 6 shows a more detailed functional block diagram of the claimed invention. The following discussion of FIG. 6 will be in conjunction with the play of golf hole 410 in FIG. 4. Block 610 resets the yardage #1 measuring data for golfer #1 to zero. After golfer #1 hits the first ball (item 612; from the tee box at 420), block 614 begins to track the number of rotations the wheel takes from point 430. At block 616, golfer #2 resets the yardage #2 measuring to zero. Golfer #2 then hits the second ball (item 618; from the tee box 421). Block 620 continues to enter the number of rotations for golfer #1 while beginning to count the representative rotations for golfer #2.

When the golf cart reach the point where the first ball has landed (item 432 in FIG. 4), the rotational information is used to calculate the distance traveled by the first golf ball and such information is displayed via block 626. Control is passed back to block 610 via golfer #1 resetting display #1 while the device continues to track rotational information (block 628) for golfer #2 since their golf shot has come to rest at a different location (position 442 in FIG. 4). After the device determines the distance traveled by golfer #2's golf shot, block 630 displays that information before that golfer resets the display #2 back to 0 and then passes control back to block 616 by pressing reset button #2.

While the present invention has been illustrated and described in connection with the preferred embodiment, it is not to be limited to the particular structure shown. It should be understood by those skilled in the art that various changes and modifications may be made within the purview of the appended claims without departing from the spirit and scope of the invention in its broader aspects.

What is claimed is:

1. A method of measuring a distance a golf ball travels per golf stroke, the method comprising the steps of:
calibrating a programming device;
storing calibration data in a non-volatile memory;
measuring, by the programming device, a number of rotations of a wheel of a golf cart as the golf cart moves from a first position to a second position;
calculating, by the programming device, a distance between the fist and second positions using the number of rotations and the stored calibration data;
displaying the distance the golf ball traveled on a display on the device; and
resetting the device by setting the distance to zero.

2. The method of claim 1, wherein the step of calibrating the programming device further comprises the steps of:
measuring a characteristic circumference of the golf cart wheel;
pressing a first button on the device;
while pressing the first button, scrolling the display until the characteristic circumference is shown; and
releasing the first button.

3. The method of claim 1, wherein the step of measuring the number of rotations of the golf cart wheel further comprises the steps of:
sensing, by first and second proximity sensors, one revolution of the golf cart wheel; and
transmitting the one revolution to the device.

4. The method of claim 3, wherein the step of transmitting is performed via a conducting wire.

5. The method of claim 3, wherein the step of transmitting is performed via a radio frequency signal.

6. The method of claim 1, wherein the step of calculating the distance between the fist and second positions further comprises the steps of:
multiplying the number of rotations by the characteristic circumference;
converting the result determined by the step of multiplying from inches to yards.

7. The method of claim 1, further comprising the steps of:
suspending the step of measuring the number of rotations of the golf cart wheel by pressing a second button on the device when the golf cart travels in a direction that is not representative of the distance the golf ball traveled; and
restarting the step of measuring the number of rotations by pressing the second button when the golf cart resumes traveling in a direction that is representative of the distance the golf ball traveled.

8. A method of measuring a distance a first golf ball travels per golf stroke, the method comprising the steps of:
calibrating a programming device;
storing calibration data in a non-volatile memory;
measuring, by the programming device, a number of rotations of a wheel of a golf cart as the golf cart moves from a first position to a second position by sensing, by first and second proximity sensors, one revolution of the golf cart wheel and transmitting the one revolution to the device;
suspending the step of measuring the number of rotations of the golf cart wheel by pressing a second button on the device when the golf cart travels in a direction that is not representative of the distance the golf ball traveled;
restarting the step of measuring the number of rotations by pressing the second button when the golf cart resumes traveling in a direction that is representative of the distance the golf ball traveled
calculating, by the programming device, a distance between the fist and second positions using the number of rotations and the stored calibration data;
displaying the distance the first golf ball traveled on a display on the device; and
resetting the device by setting the distance to zero.

9. The method of claim 8, further comprising the steps of:
measuring a distance a second golf ball travels per golf stroke concurrently while measuring the distance the first golf ball travels.

10. The method of claim 9, wherein the step of measuring the distance the second golf ball travels comprises the steps of:
measuring a second number of rotations of the golf cart wheel as the golf cart moves from a third position to a fourth position;
suspending the step of measuring the second number of rotations of the golf cart wheel by pressing the second button on the device when the golf cart travels in a direction that is not representative of the distance the second golf ball traveled;
restarting the step of measuring the second number of rotations by pressing the second button when the golf cart resumes traveling in a direction that is representative of the distance the second golf ball traveled
calculating a distance between the third and fourth positions using the second number of rotations and the stored calibration data; and
displaying the distance the second golf ball traveled on a display on the device.

11. A system for measuring a first and second distance that a first and second golf ball travels per golf stroke comprising:
a programming device attached to a golf cart, the device configured to measure the distance for the first golf ball and the second golf ball concurrently;
first and second sensors, the first and second sensors being configured to measure rotations of the wheel via pulse data; and
a transmission device electrically coupled to the programming device and second sensor.

12. The system of claim 11, wherein the device further comprises:
a first display on the device;
a first button for calibrating the device;
wherein the first button is pressably configured to control the first display so that a user can enter calibration data indicative of a characteristic circumference of a wheel of the golf cart.

13. The system of claim 12, wherein the first sensor and second sensors are mechanical proximity sensors.

14. The system of claim 12, wherein the first sensor and second sensors are magnetic proximity sensors.

15. The system of claim 14, further comprising:
a second display;
second and third buttons for resetting the first and second displays; and
a fourth button for placing the device in a suspend mode so that no measuring is performed by the device.
